(19) United States
(12) Patent Application Publication
(10) Pub. No.: US 2006/0112792 A1
(43) Pub. Date: Jun. 1, 2006

(54) Strap wrench

(75) Inventor: Qiu Jian Ping, Hangzhou (CN)

Correspondence Address: WILLIAM COLLARD;COLLARD & ROE, P.C., 1077 NORTHERN BOULEVARD, ROSLYN, NY, 11576, US

(73) Assignee: Great Neck Saw Manufacturers, Inc.

(21) Appl. No.: 10/998,856

(22) Filed: Nov. 29, 2004

(51) Int. Cl. B25B 13/52

(52) U.S. Cl. 81/64; 81/3.43

(57) ABSTRACT

A strap wrench having a head portion and a grip portion. The head portion has an upper surface and a stop ridge thereon. A lock element is pivotally mounted on said head portion and is movable relative to a stop ridge. A strap has a foot which is mounted on the lock element and is movable with it. A portion of the strap is adopted to be positioned beneath between the foot and the stop ridge so that movement of the foot by the lock element relative to the stop ridge causes the foot to strike and squeeze the strap against the stop ridge to thereby hold the strap in place.

### BACKGROUND

The present invention relates to a strap wrench and more particularly to an improved strap wrench which can grip an article, such as an oil filter, permit a torque to be applied to the article to threadably apply the article to or remove the article from a support, such as an automobile engine. Such strap wrenches comprise the use of a flexible strap which is wrapped and tightened around the article and by moving the strap wrench in one direction or the other the article is twisted and threadably removed from or applied to a support.

A number of such strap wrenches have been designed. However, they are complicated and have a large number of moving parts. This makes it difficult for the strap wrench to be operated and also increases the cost of manufacture of such earlier strap wrenches.

### OBJECTS

The present invention eliminates these problems and provides an improved strap wrench in which the strap may be easily wrapped around an article to be removed from or applied to a support.

Another object of the present invention is the provision of an improved strap wrench which has a minimum number of moving parts.

Another object of the present invention is the provision of an improved strap wrench which is easy to use and maintain.

Another object of the present invention is the provision of an improved strap wrench which is simple and inexpensive to manufacture.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is perspective view of a strap wrench made in accordance with the present invention.

FIG. 2 is a front view thereof.

FIG. 3 is a side view thereof.

FIG. 4 is a sectional view taken along line 44 of FIG. 2.

FIG. 5 is a sectional view taken along line 5-5 of FIG. 4.

FIG. 6 is a side view showing one manner of using the wrench.

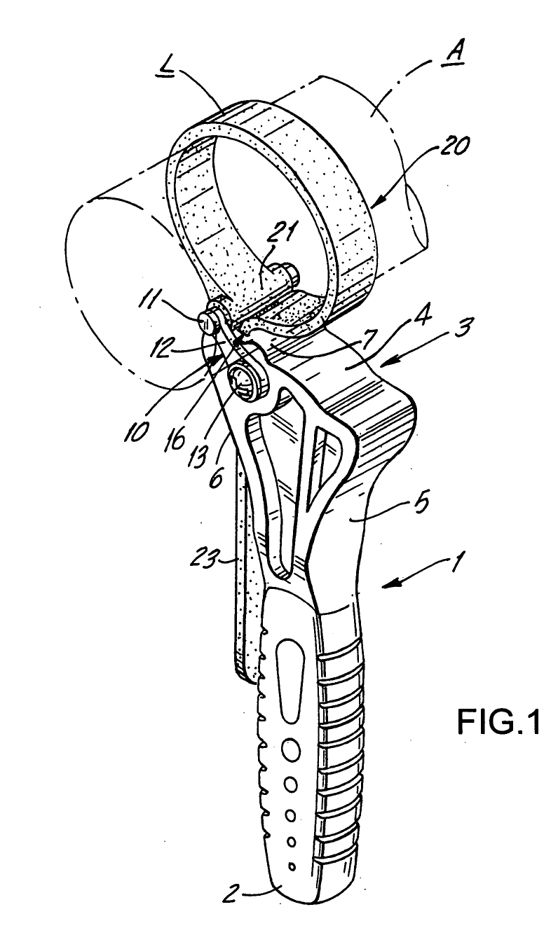

### DESCRIPTION

For convenience, the present invention will be described in connection with the use of the strap wrench on an oil filter A to be mounted and removed from an automobile engine. However, it will be understood that the present invention is not limited to its use on an oil filter but may be used on other articles, such as removing a closure cap from a jar.

Referring to the drawings, the present invention comprises a strap wrench 1 having a grip portion 2 and a head portion 3. The head portion 3 has an elongated undulating upper surface 4, an inwardly curved concave front surface 5 and inwardly curved concave rear surface 6 which is depicted as being longer than the inwardly curved concave front surface 5. The inwardly curved front and rear concave surfaces 5 and 6, respectively, merge into the grip portion 2. The upper surface 4 has a stop means, in the form of a stop ridge 7, adjacent the rear surface 6 and extending upwardly from the upper surface 4. A groove 16 is provided in the head portion 3 between the curved upper surface 4 and the inwardly curved concave rear surface 6 and connecting the two together.

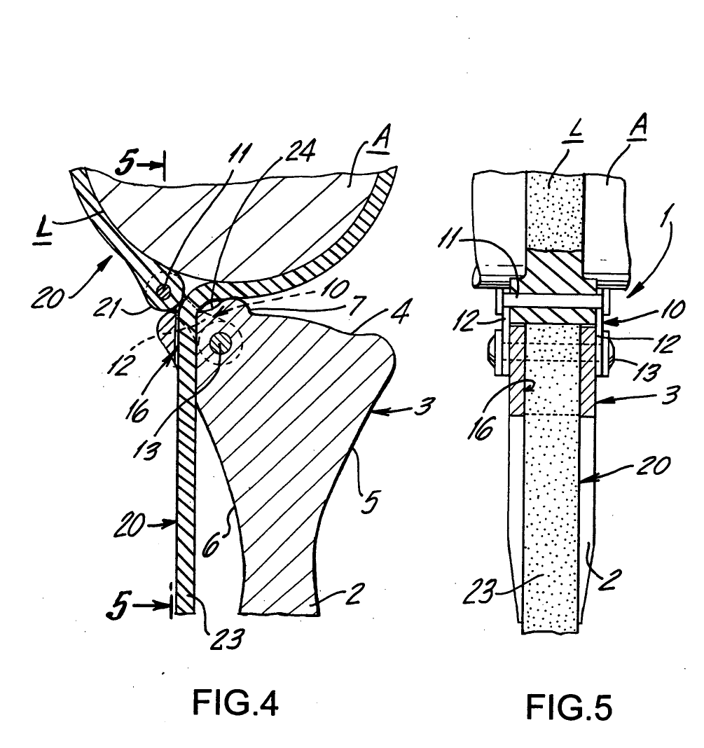

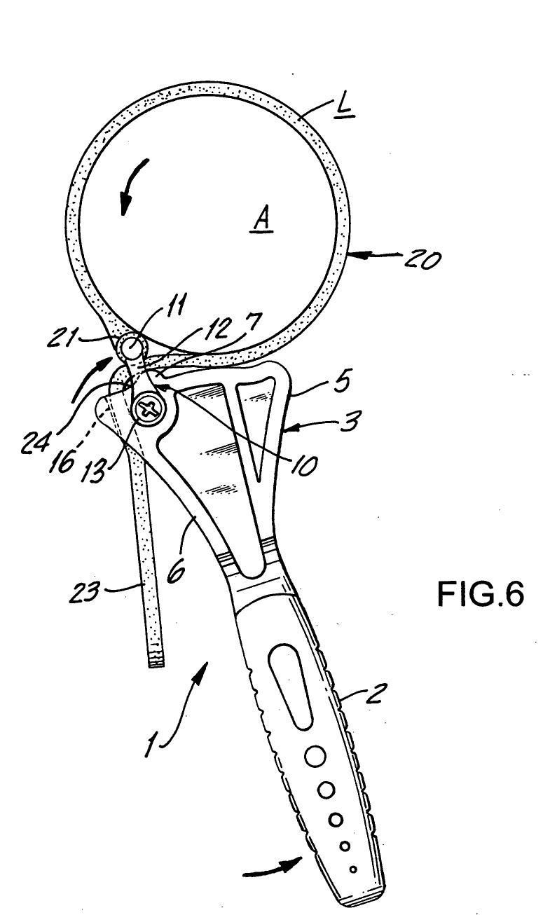

A lock means or lock element 10 is pivotally mounted on the head portion 3 by means of a pivot pin assembly 13. The lock element 10 comprises a top shaft 11 and a pair of spaced arms 12 extending downwardly from the top shaft 11. The arms 12 are positioned to straddle the upper surface 4 of the head portion 2 and to be pivotally connected thereto by means of the pivot pin assembly 13. The lock element 10 is pivotably moveable relative to the stop ridge 7 on the undulating upper surface 4 from a rearward position (FIG. 4) away from the ridge 7 to a forward position (FIG. 6) closer to the stop ridge 7.

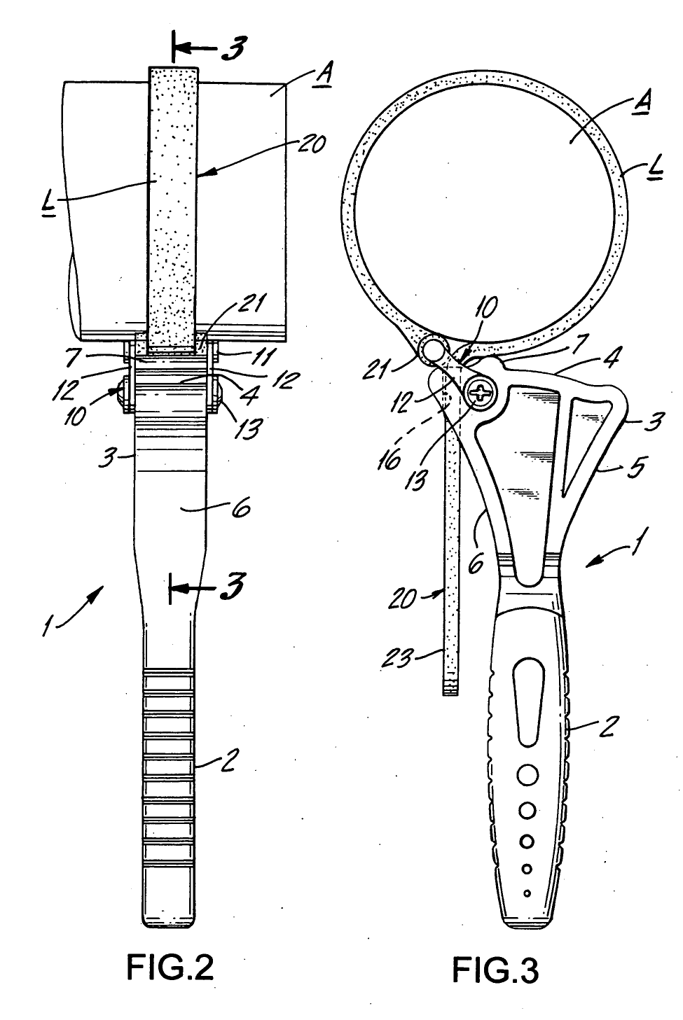

A strap 20 is mounted on said lock element 10. The strap 20 has a foot 21 which is wrapped around the shaft 11. The foot 21 may be in the form of a hollow roll within which the shaft 11 is mounted. The foot 21 is spaced from the stop ridge 7 on the upper surface 4 of the head portion 3 to form a space 24 therebetween. The strap 20 extends upwardly from its foot 21 on the shaft 11 of the lock element 10 and is bent around forwardly so that it forms a loop L. The free end 23 of the strap 20 passes under the foot 21 and through the space 24 between the foot 21 and the stop ridge 7 on the upper surface 4 of the head portion 3. The free end 23 of the strap is then passed downwardly through the groove 16 which directs the free end 23 of the strap 20 to a position adjacent the hand grip 2. It will be seen that when the lock element 10 is in its rearward position (FIGS. 2 and 4) the strap 20 can freely and easily move under the foot 21 of the strap 20 and through the space 24 so that the loop L can be made tighter around the oil filter A by pulling on the strap end 23 or the loop L may loosen its grip on oil filter A by releasing strap end 23. When the lock element 10 is pivoted to its forward position (FIG. 6) by pulling on the strap end 33 to tighten the loop L around the oil filter A, since thickness of the strap is greater than the distance between the stop ridge 7 and the foot 21 at this position, the foot 21 will strike the top surface of the strap 20 and press it against stop ridge 7 on the upper surface 4 of the head portion 3 to hold the strap 20 in the desired position. When the strap 23 is released, the lock element 10 is free to move rearwardly to it original position away from the stop ridge 7.

When the strap wrench 1 is to be used, the lock element 10 is in its normally rearwardly tilted position. The strap 20 is wrapped around an oil filter A to form a loop L around the oil filter A. The strap 20 is moved under the lock element 10 and down through the groove 16. The strap end 23 is pulled until the oil filter A is tightly held in the strap loop L. In this position the lock element 10 will tilt forwardly so that the foot 21 applies pressure to the top surface of the strap 20 to squeeze the strap 20 against the stop ridge 7 and hold the strap 20 between the foot 21 and the stop ridge 7 on the upper surface 4 of the head portion 3. The hand grip 2 and the strap end 23 are both held by the user and the strap wrench 1 is moved in a counter-clockwise direction as shown by the arrow in FIG. 6 to apply a torque on the oil filter A and unscrew or threadably loosen the oil filter from an automobile engine. When it is desired to release the grip of the loop L on the oil filter A, the user's grip on the strap end 23 is released and the stap 20 is pulled in the opposite direction. This will permit the lock element 10 to move rearwardly away from the ridge 7 thereby loosening the grip of the strap loop L on oil filter A to release it.

When it is desired to affix an oil filter A to an engine, the oil filter is mounted on the strap wrench 1 in the same manner as described above. However, the strap wrench 1 is now moved clockwise in a direction opposite from the direction shown in FIG. 6 to threadably tighten the oil filter A to the engine.

It will be understood that it is also possible to affix the oil filter A to the automobile engine by reversing the position of the strap wrench 1 so that its front and rear surfaces are reversed and moving the strap wrench 1 and the strap 20 in a direction opposite to the direction of the arrow in FIG. 6.

It will thus be seen that the present invention provides an improved strap wrench in which the strap may be easily wrapped around an oil filter to be removed from or applied to an automobile engine, which has a number of moving parts, which is easy to use and maintain, and which is easy to use and inexpensive to manufacture.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A strap wrench comprising a head portion and a grip portion said head portion comprising an upper surface having stop means thereon, lock means pivotally mounted on said head portion and movable relative to said stop means, a strap, said strap having a foot mounted on said lock means and movable therewith, a portion of said strap adopted to be positioned beneath said foot and between said foot and said stop means whereby movement of said foot by the lock means relative to the stop means causes the foot to strike and squeeze the strap against the stop means to thereby hold the strap in place.

2. A strap wrench as set forth in claim 1, wherein said stop means comprises a stop ridge on the upper surface of said head portion.

3. A strap wrench as set forth in claim 2, wherein said lock means comprises a shaft and an arm pivotally mounted on said head position.

4. A strap wrench as set forth in claim 3, wherein a pair of spaced said arms straddle the upper surface of the head portion, said arms being pivotably mounted on said head portion.

5. A strap wrench as set forth in claim 4, wherein said foot is mounted on said shaft.

6. A strap wrench as set forth in claim 5, wherein said foot is spaced from said stop ridge.

7. A strap wrench as set forth in claim 6, wherein said foot is movable from a position further away from said stop ridge to a position closer to said stop ridge whereby the foot applies pressure to the strap and hold it against said stop ridge.

8. A strap wrench as set forth in claim 7, wherein a groove is provided in said head portion adjacent said stop ridge and wherein said strap is moved through said groove to a position adjacent said grip portion after it is positioned beneath and placed between the stop ridge and the foot.

9. A strap wrench as set forth in claim 1, wherein a groove is provided in said head portion adjacent said stop means and wherein said strap is moved through said groove to a position adjacent said grip portion after it is positioned beneath the foot and placed between the stop means and the foot.

10. A strap wrench as set forth in claim 9, wherein said stop means comprises a stop ridge on the upper surface of said head portion.

11. A strap wrench as set forth in claim 10, wherein said lock means comprises a shaft and an arm pivotally mounted on said head position.

12. A strap wrench as set forth in claim 11, wherein a pair of spaced said arms straddle the upper surface of the head portion, said arms being pivotably mounted on said head portion.

13. A strap wrench as set forth in claim 12, wherein said foot is mounted on said shaft.

14. A strap wrench as set forth in claim 13, wherein said foot is spaced from said stop ridge.

15. A strap wrench as set forth in claim 14, wherein said foot is movable from a position further away from said stop ridge to a position closer to said stop ridge whereby the foot applies pressure to the strap and hold it against said stop ridge.
